(19) United States
(12) Patent Application Publication
(10) Pub. No.: US 2002/0047446 A1
(43) Pub. Date: Apr. 25, 2002

(54) Retarded series-wound motor

(76) Inventor: Christoph Meyer, Stuttgart (DE)

Correspondence Address: Scott D. Wofsy, CUMMINGS & LOCKWOOD, Four Stamford Plaza, P. O. Box 120, Stamford, CT, 06904-0210, US

(21) Appl. No.: 09/790,115

(22) Filed: Feb. 21, 2001

(30) Foreign Application Priority Data
Feb. 25, 2000 (EP) 00 103 957.7
Jul. 5, 2000 (DE) 100 32 039.2

(51) Int. Cl. H02K 1/00

(52) U.S. Cl. 310/180

(57) ABSTRACT

A retarded series-wound motor is provided which is particularly suitable as a universal motor for an electric power tool. The motor comprises a stator with at least two field poles. Each pole comprises a pole horn having a run-on edge, and further comprises a pole horn having a run-off edge. The pole horns having run-off edges are shortened in circumferential direction compared to the pole horns having run-on edges or comprise at least one cutout section extending in circumferential direction. The motor can be switched between a motor operation and a brake operation, without the need for providing commutating windings or additional coils to avoid excessive sparking.

### BACKGROUND OF THE INVENTION

The invention relates to a series-wound motor, in particular a universal motor for an electric tool, having an armature with a commutating coil, which is rotatably mounted in a stator and supplied with power by brushes. The motor comprises at least two field poles, each having a pole horn with a run-on edge and a pole horn with a run-off edge. A field coil and a switching means are provided for switching between motor operation and brake operation. In motor operation, the field coil is connected in series with the armature coil in a motor circuit supplied with a source voltage. In brake operation, the field coil forms a closed braking circuit with the armature coil, separated from the voltage source.

A series-wound motor of this type is disclosed in the German patent DE 196 36 519. The known motor is a universal motor with a pole package having a field pole arrangement of two pole portions each, where the pole package is designed for a predetermined rotary direction. The motor has a switching arrangement between motor and brake operation and includes a current path parallel to the field coil containing a diode array. To achieve good commutation both in motor operation and in brake operation, an additional field coil is provided which surrounds the field coil at the run-off edge of the two pole horns with a special configuration of the pole plates and is separately lacated at the run-on edges of the pole horns.

To ensure a sufficient commutation in motor operation, the commutation of the armature coil in universal motors is normally displaced with respect to the geometric neutral zone counter to the running direction. This normally is achieved in that the carbon brushes are shifted counter to the rotational direction of the armature out of the neutral zone. In this manner, reduced sparking is achieved, without commutator windings being necessary. If such a universal motor is to be retarded or braked by reversing the poles of the armature coil or the field coil with a switching device and by short circuiting the motor, then a deficient commutation results during the braking phase of the motor if the brushes are not adjusted or no commutating poles are provided.

This problem is avoided in the above-mentioned motor through the use of additional coils in conjunction with the special winding arrangement, however in comparison to conventional universal motors which only require a subdivided field coil and a displacement of the brushes out of the geometric neutral zone counter to the running direction of the motor, the construction of the above motor is considerably more complicated. Furthermomore, a much greater weight results for the same motor performance or, for the same weight, a reduced performance.

The use of commutating windings or additional coils to avoid the mentioned commutation problems is considered to be a drawback because such motors are used particularly for electric tools, in which a high performance with the smallest possible weight is important and in which large volumes of motors are to be produced at the most inexpensive cost.

### SUMMARY OF THE INVENTION

It is a first object of the present invention to provide an improved retarded series-wound motor, which guarantees a sufficiently good commutation in motor operation and in which excessive sparking in brake operation is avoided. It is a second object of the invention to provide an improved series wound motor which allows active braking without the need for supplementary windings. It is a further object of the invention to provide an improved series wound motor that allows self-excited braking and is very reliable.

These and other objects of the present invention are achieved in a series-wound motor of the above-mentioned type where the pole horns with run-off edges compared to the pole horns with run-on edges are shortened in circumferential direction or comprise at least one outout section or recess in circumferential direction.

Surprisingly, it has been found that no negative influence occurs during the normal motor operation mode due to the shortening of the pole horns at the run-off edge, or due to the arrangement of recesses at the run-off edge of the pole horns, while at the same time an increased commutating sparking is avoided in brake operation. The commutating armature coil can be displaced counter to the running direction from the geometric neutral zone, for which purpose the brushes are preferably arranged to be rotated counter to the rotary direction of the armature out of the neutral zone. Basically however it is also possible to configure the circuit switching connections so that it acts as a brush displacement.

Commutating windings or other additional coils can be relinquished with such an arrangement of the field poles at the runoff edges of the pole horns, because a distinctly improved commutation is achieved in this manner also in brake operation. In brake operation, an enhanced concentration of the magnetic field lines arises at the run-off side of the pole horn, while in motor operation this takes place at the run-on sides of the pole horns. The increased brush sparking in motor operation mode caused by unfavourable arrangement of the brushes is counteracted by the shortening of the pole horns on the run-off side or by the use of recesses or cutouts.

At the same time, a distinctly improved self-excitation results for self-exciting retardation, so that a reliable braking of the motor occurs when switching to the braking mode.

In a preferred embodiment of the present invention, at least two tongues are provided extending in circumferential direction on the respective run-on edges of the pole horns, between which the at least one recess is formed. In this manner, an impairment of the motor behaviour in the motor operation phase can be practically completely avoided, while at the same time, the desired improvements in the braking phase are achieved. In addition, a good placement of the field coil winding is achieved on the run-off edge of the pole horn.

As mentioned, the armature coil is preferably displaced with respect to the geometric neutral zone contrary to the preferred rotary direction.

In addition, means are preferably provided to limit the brake current flowing in brake operation. Two anti-parallel diode arrays can be employed in known manner, which are switched to be parallel to the field coil in brake operation.

According to another embodiment of the invention, a transformer is provided connected to the power grid, whose secondary winding is connected parallel to the field coil in the brake circuit, where a control switch, preferably a transistor is provided to control the current flowing in the brake circuit across the armature coil and the field coil. Preferably, the control switch is a field effect transistor, which is connected with its source and drain to be parallel with the field coil and which controls the current through the field coil depending on the current flowing in the armature coil.

With this configuration, a current is introduced into the brake circuit through the secondary winding of the transformer, which ensures a reliable initiation of braking in all circumstances. In this manner, a reliable initiation of the braking by switching to the braking mode is ensured even in the most unfavourable situations. Through the field effect transistor, it is possible to regulate the brake current even in the advanced stage of the braking process such that a strong braking moment is present. The braking characteristic is greatly improved to ensure a short braking time. The braking characteristic can be adapted such that a slow running out of the motor at the end of braking can be avoided. For this purpose, the field effect transistor is preferably connected with its gate through a voltage divider to the brushes and thus also to the armature coil.

Preferably, a load resistor is provided in the brake circuit, which is connected through a diode to one brush and one end of the field coil via a diode. One end of the load resistor is connected to the drain of the field effect transistor. The source of the field effect transistor is connected to the other brush and the other end of the field coil.

According to another preferred embodiment of the invention the secondary winding of the transformer is coupled via a rectifier circuit, preferably via a bridge rectifier in parallel to the field winding, wherein the positive output of the bridge rectifier is coupled to drain and the negative output is coupled to source of the field effect transistor.

It will be understood that the above-mentioned features and those to be discussed below are applicable not only in the given combinations but may be used in other combinations or taken alone without departing from the scope of the invention.

### SHORT DESCRIPTION OF THE DRAWINGS

Further features and advantages of the present invention can be taken from the following description of a preferred embodiment.

FIG. 1 shows a simplified circuit diagram of a motor in brake operation according to the present invention.

FIG. 2 shows a front view of the stator of the motor in FIG. 1.

FIG. 3 shows an inside view projected onto a plane of the two pole horns of the stator of FIG. 2;

FIG. 4 shows a modified circuit diagram of a motor in brake operation mode according to the present invention; and

FIG. 5 shows another modified circuit diagram of a motor in brake operation mode according to a different embodiment of the present invention.

### DETAILED DESCRIPTION OF THE PREFERRED EMBODIMENTS

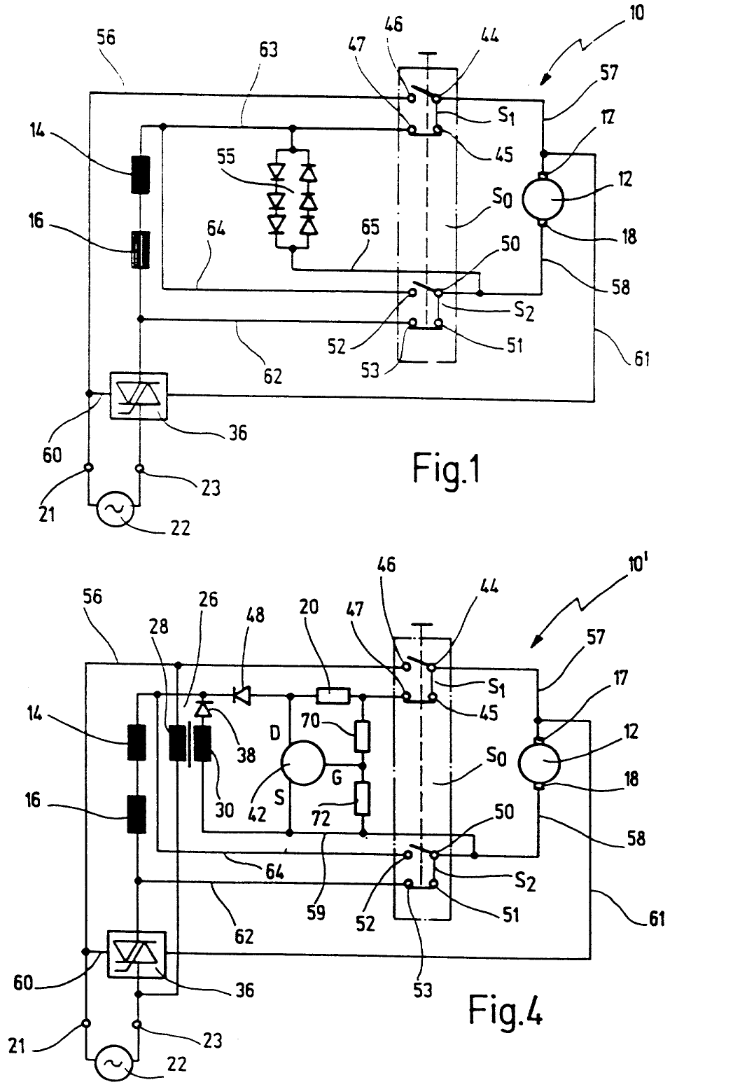

The present series-wound motor is shown in FIG. 1 and indicated with the numeral 10. The motor 10 includes an armature with an armature coil 12, which is connected in motor operation in series with a voltage source 22 through a commutator (not shown) and schematically indicated brushes 17, 18 via switching means S₀. The voltage source 22 supplies alternating current at 230 V.

The switching means S₀ has two poles including a first switch S₁ and a second switch S₂. The first pole of the voltage source 22 is connected with a line 56 to a first contact 46 of the first switch S₁ which connects to the contact 44 when the switch S₁ is closed. The contact 44 in turn is coupled to a brush 17 through a line 57. The second brush 18 is connected with a line 58 to contacts 50, 52 of the second switch S₂, the contacts being connected to one another in motor operation. The contact 52 is connected through a line 64 to a first end of the field coil 14, 16 formed in two parts. The field coil comprises a first coil part 14 and a second coil part 16, which are connected in series. The end of the second coil part 16 is connected through an electronic control 36 to the second pole 23 of the voltage source 22. The electronic control 36 is additionally connected by the control line 60 to the first pole 21 of the voltage source 22 and in addition is coupled through a control line 61 to the contacts 44, 45 of the first switch S₁.

The electronic control 36 restricts the start-up current when turning on the motor, limits the idle speed of the motor and prevents the motor from starting when a plug for connecting the voltage source 22 is plugged in at a time when the switching means S₀ is in the ON position. This electronic control 36, known per se, is connected to the second coil part 16 of the field coil, while the other coil part 14, as mentioned, is coupled to the brush 18 through the switching means S₀ in motor operation via the line 64 and the contacts 50, 52 of the second switch S₂. The suppression of interference in the series-wound motor 10 is simplified with this arrangement.

In the brake operation illustrated in FIG. 1, the contacts 44, 46 of the first switch S₁ are open, while the further contacts 45, 47 of the first switch S₁ are closed. At the same time, in brake operation, the contacts 50, 52 of the second switch S₂ are open, while the contacts 51, 53 of the second switch S₂ are closed.

An anti-parallel diode array 55 is arranged between the contact 50 of the second switch S_{2,} connected to the brush 18, and the end of the first coil part 14. The diode array is connected through a line 65 to the contact 50 and through a line 63 to the contact 47 of the first switch S₁ and to the end of the first coil part 14.

Thus in brake operation, a closed brake circuit results over the two coil parts 14, 16 of the field coil, the line 62, the contacts 53, 51, 50 of the switch S_{2,} the line 58 over the brushes 17, 18, the commutator and the armature coil 12 and the line 57 to the contacts 44, 45, 47 of the first switch S₁ and the line 63 back to the coil part 14. In addition, the anti-parallel diode array 55 in brake operation is connected in parallel to the field coil 14, 16 and to the armature coil 12.

Such a circuit is basically known, however, commutating windings or other additional coils are normally also used for retarded motors in the prior art, which are located in the brake circuit.

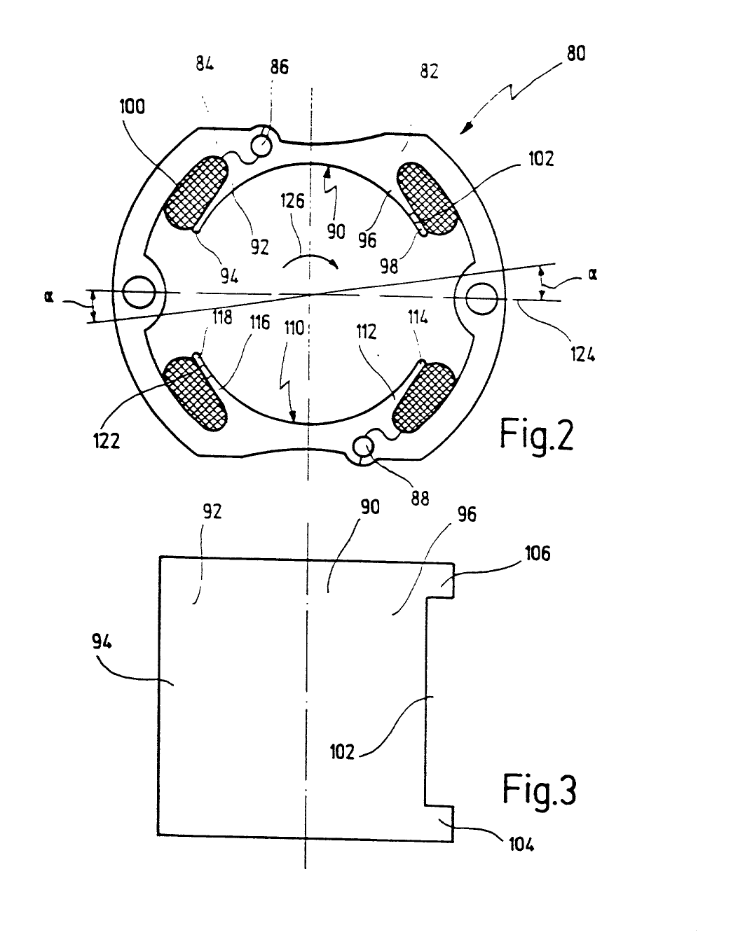

FIG. 2 shows the configuration of a stator 80 according to the present invention. The stator 80 is preferably formed of two halves 82, 84 as is disclosed in detail in the German patent application DE 195 07 264. The construction simplifies the assembly of the coil parts of the field windings onto the stator 80. After mounting the coil packages 100, the two halves 82, 84 are secured to one another by inserting the pins 86, 88 in the corresponding openings, so that the stator 80 forms a closed annular yoke.

The stator 80 has a first field pole 90 and a second field 110 lying opposite to one another. Each of the field poles 90, 110 comprises two pole horns 92, 96 and 112, 116. The preferred rotary direction of the motor is indicated with the arrow 126. Thus the first field pole 90 has a pole horn 92 with a run-on edge 94 and a pole horn 96 with a run-off edge 98. Similarly, the second field pole 110 has a pole horn 112 with a run-on edge 114 and a pole horn 116 with a run-off edge 118.

The two pole horns 96, 116 with run-off edges 98, 118 each comprise a recess 102, 122 when viewed in circumferential direction, as can be seen in detail in FIG. 3. FIG. 3 shows a view of the first field pole 90 from the inside where the view is projected onto a flat plane.

The horn 92 on the side of the run-on edge 94 is configured in conventional manner out of the layers of sheet metal to be solid, i.e. without recesses. On the other hand, the horn 96 on the side of the run-off edge 98 comprises a recess 102 extending in axial direction of the stator 80, which is enclosed at both axial ends of the horn 96 through tongues 104, 106 projecting in circumferential direction.

The horns 92, 96 are generally symmetrical to one another, where the horn 96 is only shortened at the run-off edge 98 by the recess 102, while the extension of the tongues 104, 106 corresponds to the dimensions of the other horn 92. A corresponding recess is provided in the other horn 116 of the second field pole 110, which is only indicated in FIG. 2 with the numeral 122.

FIG. 2 also shows the geometric neutral zone indicated by the line 124. The brushes 17, 18 of the motor 10 are arranged to be shifted contrary to the rotary direction 126 by an angle á, as it is generally known in such universal motors to improve the commutation in motor operation and to avoid sparking.

The commutation in brake operation is considerably improved by the recesses 102, 122 on the run-off sides of the horns 96, 116, without the necessity of commutating windings or additional coils. At the same time, practically no disadvantages arise for the motor operation.

It will be understood that the tongues 104, 106 and the recess 102 of FIG. 3 only represent an example. Additional or differently formed tongues can also be provided. The form and arrangement of the recess or recesses at the run-off sides of the horns can also be varied.

A distinctly improved self-excitation in brake operation is ensured with the given configuration of the horns 96, 116 at the run-off edges 98, 118, so that in the simplest case the circuit of FIG. 1 is sufficient to guarantee a reliable initiation of braking when switching to brake operation.

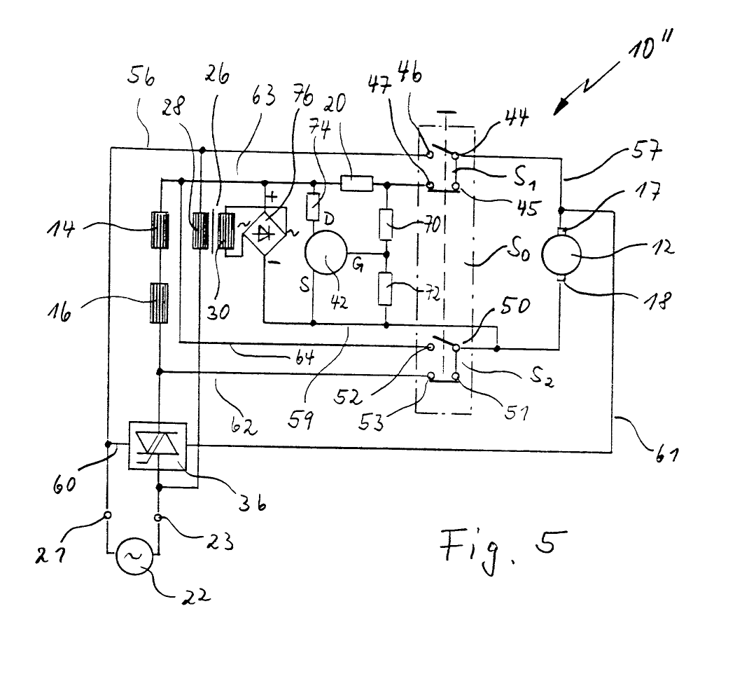

An even greater reliability in initiating braking and also a particularly advantageous braking characteristic, i.e. the braking behaviour with time, can be achieved with the modified circuit shown in FIG. 4. FIG. 4 shows a series-wound motor indicated generally with the numeral 10′. Parts corresponding to those given in FIG. 1 are indicated with the same reference numerals.

The basic configuration of the circuit corresponds to the embodiment of FIG. 1, where however the anti-parallel diode array 55 is removed and instead a transformer 26 is provided together with a field effect transistor circuit.

The transformer 26 is connected at its primary side 28 directly to the two poles 21, 23 of the voltage source 22. At its secondary side 30, the transformer 26 is connected through a diode 38 to the one end of the first part 14 of the field coil and at its other end is connected through a line 59 to the contact 50 of the second switch S₂ as well as through the line 58 to the brush 18 of the armature coil 12. As seen in FIG. 4, the brush 18 in brake operation is connected to the end of the second part 16 of the field coil through the line 58 and the contacts 50, 51, 53 of the second switch S₂ and the line 62.

A field effect transistor 42 of the type IRF 540 is coupled with the drain D through a diode 48 to the end of the first coil part 14 and therefore it is also coupled to the diode 38. Both diodes 38, 48 are thus connected with their cathodes to the end of the first coil part 14. The field effect transistor 42 is connected with its source S through the line 59 to the contact 50 of the second switch S₂ and therefore through the line 58 to the brush 18 of the armature coil 12. The anode of the diode 48 is connected through a load resistor 20 to the contact 47 of the first switch S₁, which in the indicated brake operation position is connected through the contacts 45, 44 with the line 57 to the brush 17.

The field effect transistor 42 is connected with its gate G through a voltage divider 70, 72 between the contact 47 of the first switch S₁ and the line 59, which connects to the contact 50 of the second switch S₂. The voltage divider comprises a first resistor 70, having for example 1 kOhm and a second resistor 72 having a rating of 6 kOhm. The resistor 70 is connected at one end to the contact 47 of the switch S₁ and with its other end to the resistor 72, which in turn is connected to the contact 50 of the switch S₂. The gate G of the field effect transistor is connected between the resistors 70, 72. A Zener diode could also be provided instead of the resistor 70, which generates the desired switching voltage.

The field effect transistor 42 is triggered at its gate G by the voltage divider 70, 72, where the voltage is taken off at the interconnection of the resistors 70, 72. The field current is regulated in brake operation in the motor of FIG. 4 by the field effect transistor 42 and the armature voltage is held nearly constant during the brake operation until it finally falls off at the end of the braking process. The dimensioning for a motor having a power rating of about 2000 W at 230 V alternating current is designed such that the transformer has a secondary voltage of 4 V at a power level of 0.25 W. A field effect transistor 42 of the type MOSFET IRF 540 can be used, which is designed for a maximum current of 28 A and a maximum stray power of 125 W. A load resistor 20 can be used with a resistance of 0.33 Ohm at a stray power of 10 W. As mentioned, the voltage divider can consist of the resistor 70 having 1 kOhm and the resistor 72 having 6 kOhm.

The field effect transistor 42 becomes conductive during the brake operation when a voltage of about 4 V is applied by the voltage divider 70, 72 between the gate G and the source S. Voltage is applied to the load resistor 20 which depends on the amount of current flowing through the armature coil 12, so that in this embodiment the armature voltage remains nearly constant during the brake operation and the field current is regulated by the field effect transistor 42.

At the end of the brake operation, the armature voltage falls off strongly, so that the field effect transistor 42 goes over to the non-conductive state. The field current flowing through the field coils 14, 16 rises again for a short time, so that the braking effect at the end is enhanced.

The above embodiment is particularly advantageous for a angle-iron grinder with a high power rating of about 2000 W because it shows a particularly favourable braking characteristic.

In FIG. 5 a further circuit configuration of a series-wound motor according to the current invention is indicated generally with the numeral 10 2′. Parts corresponding to those given in FIG. 4 are indicated with the same reference numerals.

The basic configuration of the circuit corresponds to the embodiment of FIG. 4, wherein merely the diodes 38 and 48 were deleted. Instead, the secondary winding 30 of the transformer 26 feeds the input ends of a bridge rectifier 76, the output ends of which are connected at the positive pole to line 63 which is connected with field winding 14, while the negative pole of the output end of the bridge rectifier 76 is connected with source S of the field effect transistor 42. Resistor 20 is now directly coupled to field coil 14 and the positive pole of bridge rectifier 76. Diferring from the circuit according to FIG. 4, drain D of the field transistor 42 is coupled to resistor 20 and to field winding 14 via a resistor 74 which may be selected to be 0.15 Ohm, while the remaining portions of the circuit can be equally designed as previously explained with respect to FIG. 4.

Since according to this embodiment diode 48 in the brake circuit was deleted, also the problem inherent thereto is avoided. Namely, in the embodiment according FIG. 4, when the voltage drops to the threshold value of the diode, which is roughly 0.7 to 0.8 V, the current flow stops. In the embodiment according to FIG. 5, now the braking or retardation continues until the braking operation is fully completed. Also it is avoided that during the time in which diode 48 according to FIG. 4 is in the blocking state, a self-excitation occurs in a direction contrary to braking, which otherwise might occur under unfavorable conditions.

For a reliable operation of the circuit according to FIG. 5, the switch S₀ should be designed such, that when switching from the motor operation mode into the braking mode after opening contacts 44, 46 and 50, 52, respectively, in the beginning the connection between contacts 51 und 53 is closed, before the connection between contacts 45 and 47 is closed.

The bridge rectifier 76 in connection with such a switch S₀ thus clearly predefines the direction of self-excitation under all conditions in the braking mode.

What is claimed is:

1. A series-wound motor having a preferred rotary direction, said motor comprising:
an armature including a commutating armature coil;
a stator within which said armature is mounted rotatably;
brushes connectable to a voltage source for sliding contact with said armature coil;
at least two field poles provided on said stator, each said field pole comprising a center line extending axially through said field pole and two pole horns extending circumferentially outwardly from said center line, one of said pole horns extending from said center line contrary to said preferred rotary direction and ending in a run-on edge, another one of said pole horns extending from said center line within said preferred rotary direction and ending in a run-off edge;
at least one field coil;
switching means for switching said motor between a motor operation mode and a braking mode, wherein, when being in said motor operation mode, said field coil is connected in series with said armature coil in a motor circuit fed by said voltage source, and wherein, when being in said braking mode, said field coil forms a closed brake circuit with said armature coil being separated from said voltage source;
wherein said run-off edges of said pole horns each comprise at least one cutout section extending between two axial ends of said pole horn from said run-off edge circumferentially toward said center line, said run-off edge at said cutout section having a smaller distance from said center line in circumferential direction than has said run-on edge from said center line.

2. The motor of claim 1, wherein said run-off edges of said pole horns each comprise at least two tongues extending in circumferential direction, between which said cutout section is formed.

3. The motor of claim 1, wherein the stator comprises a geometric neutral zone, said commutating armature coil being displaced with respect to said geometric neutral zone counter to the preferred rotary direction.

4. The motor of any one of the preceding claims, further comprising means for restricting the current flowing in the brake mode within said brake circuit.

5. The motor of claim 4, further comprising a transformer having a primary winding and a secondary winding, said primary winding being fed by an alternating voltage source also feeding the motor when being in operating mode, said secondary winding being connected in parallel with the field coil in the brake circuit, when being in braking mode, and further comprising an electronic control switch for controlling the current flowing in the brake circuit across the armature coil and the field coil.

6. The motor of claim 5, wherein the control switch is a field effect transistor having a source, a drain and a gate, said field effect transistor being coupled in parallel with its source and its drain to the field coil via a diode and regulating the current through the field coil depending on the current flowing across the armature coil.

7. The motor of claim 5, wherein the secondary winding is connected in parallel with the field coil in the brake circuit via a rectifier.

8. The motor of claim 6, wherein the field effect transistor in the brake circuit is connected with its gate to the brushes via a voltage divider.

9. The motor of claim 8, further comprising a load resistor being connected in the brake circuit between one of said brushes and one end of the field coil via a diode, wherein the drain of the field effect transistor is connected to one end of the load resistor, and wherein the source of the field effect transistor is connected to another one of said brushes and another end of the field coil.

10. A series-wound motor having a preferred rotary direction, said motor comprising:
an armature including a commutating armature coil;
a stator within which said armature is mounted rotatably;
brushes connectable to a voltage source for sliding contact with said armature coil;
at least two field poles provided on said stator, each said field pole comprising a center line extending axially through said field pole and two pole horns extending circumferentially outwardly from said center line, one of said pole horns extending from said center line contrary to said preferred rotary direction and ending in a run-on edge, another one of said pole horns extending from said center line within said preferred rotary direction and ending in a run-off edge;
at least one field coil;
switching means for switching said motor between a motor operation mode and a braking mode, wherein, when being in said motor operation mode, said field coil is connected in series with said armature coil in a motor circuit fed by said voltage source, and wherein, when being in said braking mode, said field coil forms a closed brake circuit with said armature coil being separated from said voltage source;
wherein said run-off edges of said pole horns each have a smaller distance in circumferential direction from said center line than have said run-on edges from said center line.

11. The motor of claim 10, wherein said run-off edges of said pole horns each comprise at least two tongues extending in circumferential direction, between which said cutout section is formed.

12. The motor of claim 10, wherein the stator comprises a geometric neutral zone, said commutating armature coil being displaced with respect to said geometric neutral zone counter to the preferred rotary direction.

13. The motor of claim 10, further comprising means for restricting the current flowing in the brake mode within said brake circuit.

14. The motor of claim 13, further comprising a transformer having a primary winding and a secondary winding, said primary winding being fed by an alternating voltage source also feeding the motor when being in operating mode, said secondary winding being connected in parallel with the field coil in the brake circuit, when being in braking mode, and further comprising an electronic control switch for controlling the current flowing in the brake circuit across the armature coil and the field coil.

15. The motor of claim 14, wherein the control switch is a field effect transistor having a source, a drain and a gate, said field effect transistor being coupled in parallel with its source and its drain to the field coil via a diode and regulating the current through the field coil depending on the current flowing across the armature coil.

16. The motor of claim 15, wherein the secondary winding is connected in parallel with the field coil in the brake circuit via a rectifier.

17. The motor of claim 15, wherein the field effect transistor in the brake circuit is connected with its gate to the brushes via a voltage divider.

18. The motor of claim 17, further comprising a load resistor being connected in the brake circuit between one of said brushes and one end of the field coil via a diode, wherein the drain of the field effect transistor is connected to one end of the load resistor, and wherein the source of the field effect transistor is connected to another one of said brush and another end of the field coil.

19. The motor of claim 4, further comprising a transformer having a primary winding and a secondary winding, said primary winding being fed by an alternating voltage source also feeding the motor when being in operating mode, said secondary winding being connected via a retifier circuit in parallel with the field coil in the brake circuit, when being in braking mode, and further comprising an electronic control switch for controlling the current flowing in the brake circuit across the armature coil and the field coil.

20. The motor of claim 19, wherein the control switch is a field effect transistor having a source, a drain and a gate, said field effect transistor being coupled in parallel with its source and its drain to the field coil and regulating the current through the field coil depending on the current flowing across the armature coil.

21. The motor of claim 20, further comprising a bridge rectifier, said bridge rectifier having A.C. input ends being coupled to the secondary winding and having D.C. output ends being connected in parallel with the field coil in the brake circuit, wherein a positive voltage output end of said bridge rectifier is coupled to the drain of said field effect transistor, and wherein a negative voltage output end of said bridge rectifier is coupled to the source of said field effect transistor.

22. The motor of claim 19, wherein the field effect transistor in the brake circuit is connected with its gate to the brushes via a voltage divider.

23. A series-wound motor having a preferred rotary direction, said motor comprising:
an armature including a commutating armature coil;
a stator within which said armature is mounted rotatably;
brushes connectable to a voltage source for sliding contact with said armature coil;
at least one field coil;
switching means for switching said motor between a motor operation mode and a braking mode, wherein, when being in said motor operation mode, said field coil is connected in series with said armature coil in a motor circuit fed by said voltage source, and wherein, when being in said braking mode, said field coil forms a closed brake circuit with said armature coil being separated from said voltage source;
a transformer having a primary winding and a secondary winding, said primary winding being fed by an alternating voltage source also feeding the motor when being in operating mode, said secondary winding being connected in parallel with the field coil in the brake circuit, when being in braking mode, and further comprising an electronic control switch for controlling the current flowing in the brake circuit across the armature coil and the field coil.

24. The motor of claim 23, wherein the control switch is a field effect transistor having a source, a drain and a gate, said field effect transistor being coupled in parallel with its source and its drain to the field coil and regulating the current through the field coil depending on the current flowing across the armature coil.

25. The motor of claim 24, further comprising a bridge rectifier, said bridge rectifier having A.C. input ends being coupled to the secondary winding and having D.C. output ends being connected in parallel with the field coil in the brake circuit, wherein a positive voltage output end of said bridge rectifier is coupled to the drain of said field effect transistor, and wherein a negative voltage output end of said bridge rectifier is coupled to the source of said field effect transistor.

26. The motor of claim 25, wherein the field effect transistor in the brake circuit is connected with its gate to the brushes via a voltage divider.
